(19) United States
(12) Patent Application Publication
(10) Pub. No.: US 2025/0155239 A1
(43) Pub. Date: May 15, 2025

(54) TEMPERATURE COMPENSATION APPARATUS, MEASUREMENT SYSTEM, AND TEMPERATURE COMPENSATION METHOD

(71) Applicant: MITUTOYO CORPORATION, Kanagawa (JP)

(72) Inventors: Makoto ABE, Kanagawa (JP); Hironobu KAWAMURA, Aichi (JP)

(73) Assignee: MITUTOYO CORPORATION, Kanagawa (JP)

(21) Appl. No.: 18/934,580

(22) Filed: Nov. 1, 2024

(30) Foreign Application Priority Data
Nov. 10, 2023 (JP) 2023-192122

(51) Int. Cl. G01B 21/04

(52) U.S. Cl. CPC G01B 21/045

(57) ABSTRACT

A temperature compensation apparatus including: a measured temperature acquisition part that acquires temperatures of the three-dimensional measurement apparatus during measurement; a measurement result acquisition part that acquires a measurement result of an object to be measured output by the three-dimensional measurement apparatus; a correction value calculation part that calculates a correction value of the measurement result using a model formula of temperature compensation, including a polynomial composed of values obtained by multiplying each of a plurality of temperatures by coefficients corresponding to each of the plurality of temperature sensors; and a correction part that calculates a corrected measurement value, which is a corrected measurement result obtained by adding the correction value to the measurement result or multiplying the correction value by the measurement result.

### CROSS-REFERENCE TO RELATED APPLICATIONS

The present application claims priority to Japanese Patent Application number 2023-192122, filed on Nov. 10, 2023, contents of which are incorporated herein by reference in their entirety.

### BACKGROUND OF THE INVENTION

The present disclosure relates to a temperature compensation apparatus, a measurement system, and a temperature compensation method. A measurement apparatus that measures a three-dimensional geometry of a measurement target in a contact or non-contact manner has been known (for example, refer to Patent Document 1, Japanese Unexamined Patent Application Publication Number JP 2004-341608 and Patent Document 2, Japanese Translation of PCT International Application Publication Number JP 2019-507885.) Such a measurement apparatus can accurately measure the three-dimensional geometry of the measurement target when environmental temperature is stable. In other words, the measurement apparatus needs the environmental temperature to be stable in order to perform measurements with high accuracy.

In a case where such a measurement apparatus is installed in an environment in which temperature fluctuates, such as in a factory, thermal expansion or the like may occur in various parts of an object to be measured and the measurement apparatus, causing an error in a measurement result. Conventionally, methods such as calculating an amount of the thermal expansion of an object to be measured on the basis of its temperature and correcting the measurement result of the measurement apparatus, or correcting simple expansion and contraction of scales or the like, have been known. However, temperature unevenness or the like in the object to be measured can occur, leading to cases where high-accuracy measurement results cannot be obtained.

### BRIEF SUMMARY OF THE INVENTION

The present disclosure focuses on these points, and its object is to make it possible to easily and accurately correct an error in a measurement result of a three-dimensional measurement apparatus caused by environmental temperature changes.

According to a first aspect of the present disclosure, there is provided a temperature compensation apparatus which performs temperature compensation on a measurement result of an object to be measured, output by a three-dimensional measurement apparatus installed in a variable temperature environment, the temperature compensation apparatus including: a measured temperature acquisition part that acquires temperatures of the three-dimensional measurement apparatus during measurement, from a plurality of temperature sensors provided at a plurality of different positions of the three-dimensional measurement apparatus, a temperature sensor that measures an environmental temperature of the three-dimensional measurement apparatus, and a temperature sensor that measures a temperature of the object to be measured; a measurement result acquisition part that acquires the measurement result of the object to be measured output by the three-dimensional measurement apparatus; a correction value calculation part that calculates a correction value of the measurement result using a model formula of temperature compensation, including a polynomial composed of values obtained by multiplying each of a plurality of temperatures acquired from the plurality of temperature sensors by coefficients corresponding to each of the plurality of temperature sensors; and a correction part that calculates a corrected measurement value, which is a corrected measurement result obtained by adding the correction value to the measurement result or multiplying the correction value by the measurement result, wherein the coefficients corresponding to each of the plurality of temperature sensors are values identified so as to minimize an evaluation function based on a difference between an ideal measurement value obtained by measuring the object to be measured installed in a constant temperature environment at a predetermined temperature and the correction value.

A second aspect of the present disclosure provides a measurement system including: the three-dimensional measurement apparatus that measures a three-dimensional geometry of the object to be measured; a plurality of temperature sensors provided at a plurality of different positions of the three-dimensional measurement apparatus; and the temperature compensation apparatus according to the first aspect of the present disclosure that performs temperature compensation on the measurement result of the three-dimensional measurement apparatus on the basis of a plurality of temperatures acquired by the plurality of temperature sensors.

A third aspect of the present disclosure provides a temperature compensation method which performs temperature compensation on a measurement result of an object to be measured, output by a three-dimensional measurement apparatus installed in a variable temperature environment, the temperature compensation method including the steps of: acquiring temperatures of the three-dimensional measurement apparatus during measurement, from a plurality of temperature sensors provided at a plurality of different positions of the three-dimensional measurement apparatus, and a temperature sensor that measures an environmental temperature of the three-dimensional measurement apparatus; acquiring the measurement result; calculating a correction value of the measurement result using a model formula of temperature compensation, including a polynomial composed of values obtained by multiplying each of a plurality of temperatures acquired from the plurality of temperature sensors by coefficients corresponding to each of the plurality of temperature sensors; and calculating a corrected measurement value, which is a corrected measurement result obtained by adding the correction value to the measurement result or multiplying the correction value by the measurement result, wherein the coefficients corresponding to each of the plurality of temperature sensors are values identified so as to minimize an evaluation function based on a difference between an ideal measurement value obtained by measuring the object to be measured installed in a constant temperature environment at a predetermined temperature and the correction value.

### BRIEF DESCRIPTION OF THE DRAWINGS

FIG. 1 shows a configuration example of a measurement system S according to the present embodiment.

FIG. 2 shows a configuration example of a temperature compensation apparatus 100 according to the present embodiment.

FIG. 3 shows an example of an operation flow of the temperature compensation apparatus 100 according to the present embodiment.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Configuration Example of a Measurement System S

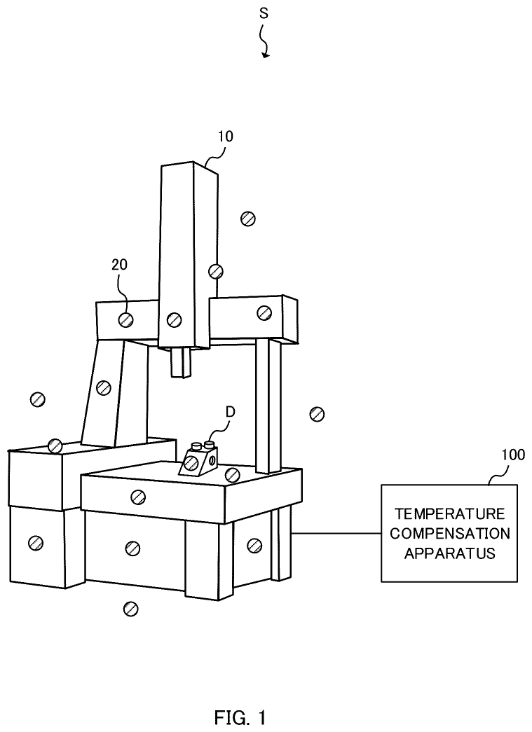

FIG. 1 shows a configuration example of a measurement system S according to the present embodiment. The measurement system S performs temperature compensation for a measurement error of temperature in a measurement result by a measurement apparatus, caused by environmental temperature changes. The measurement system S includes a three-dimensional measurement apparatus 10, a plurality of temperature sensors 20, and a temperature compensation apparatus 100.

The three-dimensional measurement apparatus 10 measures a three-dimensional geometry of an object to be measured D. The three-dimensional measurement apparatus 10 includes a coordinate measurement part that measures three-dimensional coordinates of the object to be measured D, and a controller (for example, a computer) that calculates a shape, a spatial positional relationship, a distance between a plurality of positions, and the like of the object to be measured D on the basis of a plurality of identified three-dimensional coordinates, for example. The three-dimensional measurement apparatus 10 measures the three-dimensional geometry of the object to be measured D by measuring three-dimensional coordinates of a plurality of positions of the object to be measured D. Since such a three-dimensional measurement apparatus 10 is known and described in Patent Document 1 and the like, a detailed description of the three-dimensional measurement apparatus 10 will be omitted here.

The plurality of temperature sensors 20 are provided at a plurality of different positions of the three-dimensional measurement apparatus 10. Among the plurality of temperature sensors 20, at least one temperature sensor 20 measures an environmental temperature of the three-dimensional measurement apparatus 10. Further, at least one temperature sensor 20 measures a temperature of the object to be measured D. The plurality of temperature sensors 20 are resistance temperature detectors using platinum or similar materials, thermocouples, thermistors, or the like, for example.

On the basis of the temperatures measured by the plurality of temperature sensors 20, the temperature compensation apparatus 100 performs temperature compensation on a measurement result of the object to be measured D, output by the three-dimensional measurement apparatus 10 installed in a variable temperature environment. The three-dimensional measurement apparatus 10 can accurately measure the three-dimensional geometry of the object to be measured D in an environment in which the temperature is stable, such as a measurement room or a laboratory. However, when the three-dimensional measurement apparatus 10 is installed in an environment in which the temperature fluctuates, such as in a factory, thermal expansion may occur in each part of the three-dimensional measurement apparatus 10 due to a change in environmental temperature, heat generation from the apparatus itself, or other factors, potentially causing an error in the measurement result. It is conceivable to perform simple correction for thermal expansion, but it was sometimes difficult to accurately correct the error in the measurement result.

Conventionally, a temperature TD of the object to be measured D, measured by the three-dimensional measurement apparatus 10, is used to correct a measurement result of the three-dimensional measurement apparatus 10 on the basis of a temperature expansion amount a_{w}×(T_{D}−T_{E})×L_{S} of the object to be measured D, calculated from a temperature difference (T_{D}−T_{E}) between the temperature T_{D} and a predetermined environmental temperature T_{E} (e.g., T_{E}=20° C.) Here, aw is the coefficient of thermal expansion.

For example, when the three-dimensional measurement apparatus 10 measures a distance between the center positions of two holes provided in the object to be measured D and its measurement result is L_{S}, the controller of the three-dimensional measurement apparatus 10 corrects the measurement result L_{S} of the three-dimensional measurement apparatus 10 with the following equation to calculate a corrected measurement value L_{S}′.

$${L}_{S}^{′} = {L}_{S} \cdot \{ 1 - {a}_{W} \cdot ( {T}_{D} - {T}_{E} ) \} \qquad [ Equation 1 ]$$

However, if the change in environmental temperature is significant or happens quickly, temperature unevenness can occur in the object to be measured D, causing a correction amount of the measurement result to differ from the actual expansion amount of the object to be measured D, leading to a decrease in the measurement accuracy.

In addition, the change in the expansion amount of the object to be measured D may sometimes follow the change in the temperature of the object to be measured D with a time delay. For example, when the temperature of the object to be measured D decreases from a high temperature side to a first temperature in response to the change in the environmental temperature, there are cases where the object to be measured D is in an expanded state.

In addition, when the temperature of the object to be measured D increases from a low temperature side to the first temperature in response to a change in the environmental temperature, there are cases where the object to be measured D is in a contracted state, for example. Therefore, in a variable temperature environment, even if the temperature of the object to be measured D is at the first temperature, the expansion amount of the object to be measured D may differ. Therefore, the measurement result could not always be accurately corrected by the conventional correction formula, such as Equation 1.

Further, since various measurement items are measured for the object to be measured D of the three-dimensional measurement apparatus 10, using a single correction formula may result in variation between items where the error could be reduced and items where the error could not be reduced. Further, when the object to be measured D is not formed of a uniform material, it may be difficult to accurately identify the coefficient of thermal expansion or the like of the object to be measured D. When the object to be measured D has a complex shape or a large volume, the temperature may not be uniform, making it difficult to accurately identify the temperature. Therefore, the temperature compensation apparatus 100 makes it possible to easily and accurately correct an error in a measurement result of the three-dimensional measurement apparatus 10 caused by environmental temperature changes. Next, such a temperature compensation apparatus 100 will be described.

### Configuration Example of the Temperature Compensation Apparatus 100

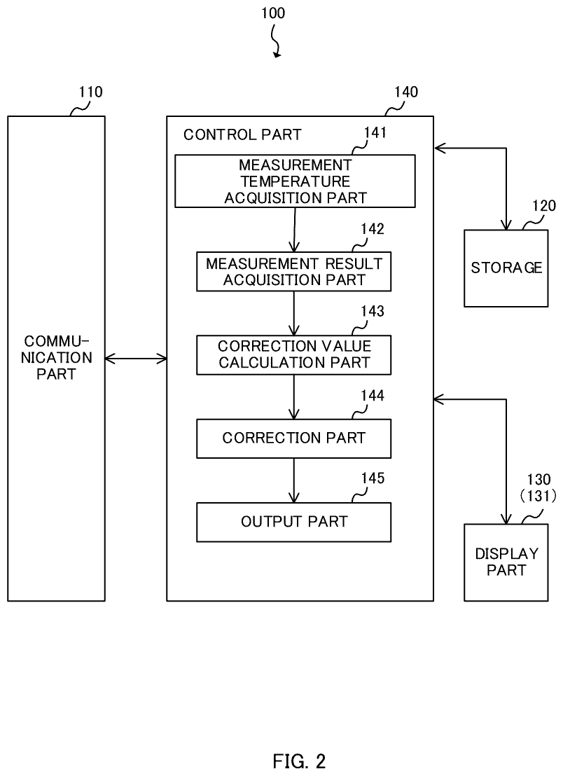

FIG. 2 shows a configuration example of the temperature compensation apparatus 100 according to the present embodiment. The temperature compensation apparatus 100 is, for example, a computer such as a PC or server. The temperature compensation apparatus 100 includes a communication part 110, a storage 120, a display part 130, and a control part 140.

The communication part 110 communicates with the three-dimensional measurement apparatus 10. The communication part 110 may be directly connected to the three-dimensional measurement apparatus 10, or instead, may communicate via a communication network or the like. The communication part 110 may include an interface for connecting to the communication network such as a LAN, an Internet line, or a mobile phone network. The communication part 110 may be accessible to an external server, PC, database, or the like.

By communicating with the three-dimensional measurement apparatus 10, the communication part 110 acquires information about the measurement result of the three-dimensional measurement apparatus 10 and information about the temperatures measured by the plurality of temperature sensors 20. The measurement result is, for example, a position of a predetermined portion calculated by the three-dimensional measurement apparatus 10 on the basis of the plurality of three-dimensional coordinates, a position of the center of a circle, a position of the center of a sphere, the diameter of a hole, a distance between end faces, a distance between two predetermined portions, a relative position between two predetermined portions, a shape of a measured element, a posture of the element, or the like.

It should be noted that the communication part 110 may directly communicate with the plurality of temperature sensors 20 to acquire information about the temperatures measured by the temperature sensors 20. In addition, in a case where the controller or the like that controls the measurement operation of the three-dimensional measurement apparatus 10 is provided, the communication part 110 may communicate with said controller to acquire the information about the measurement result of the three-dimensional measurement apparatus 10, the information about the temperatures measured by the temperature sensors 20, and the like.

The storage 120 includes a storage medium such as a read only memory (ROM), a random access memory (RAM), or the like. The storage 120 may include a large-capacity storage device like a hard disk drive (HDD) and/or a solid state drive (SSD). As an example, when the computer functions as the temperature compensation apparatus 100, the storage 120 may store an operating system (OS) that causes the computer to function, and information such as a program. The storage 120 may store various types of information including a program for causing the three-dimensional measurement apparatus 10 to operate and a database referred to at the time of execution of various programs.

In addition, the storage 120 may store intermediate data, calculation results, threshold values, reference values, parameters, and the like generated (or used) during the operation of the temperature compensation apparatus 100. For example, the storage 120 may store the information about the measurement result of the three-dimensional measurement apparatus 10, the information about the temperatures measured by the plurality of temperature sensors 20, and the like. The storage 120 may be a database or the like provided outside the temperature compensation apparatus 100. The storage 120 may supply the stored data to the request source in response to a request from each part in the temperature compensation apparatus 100.

The display part 130 displays the information about the measurement result of the three-dimensional measurement apparatus 10, the information about a correction result by the temperature compensation apparatus 100, and the like. The display part 130 may also function as a display for displaying an operation state of the three-dimensional measurement apparatus 10, an operation state and a communication state of the temperature compensation apparatus 100, an OS, an execution state of programs, and the like. The display part 130 may have a touch panel function and operate as an input part 131. An operation, an instruction, and the like from a user of the temperature compensation apparatus 100 are input to the input part 131. The input part 131 may be an input device separate from the display part 130, such as a keyboard, a mouse, or an audio input device.

The control part 140 controls each part of the temperature compensation apparatus 100. The control part 140 is a CPU (Central Processing Unit), for example. The control part 140 includes a measurement temperature acquisition part 141, a measurement result acquisition part 142, a correction value calculation part 143, a correction part 144, and an output part 145. In other words, the CPU functions as the control part 140 including the measurement temperature acquisition part 141, the measurement result acquisition part 142, the correction value calculation part 143, the correction part 144, and the output part 145 by executing the programs stored in the storage 120.

The measurement temperature acquisition part 141 acquires temperatures of the three-dimensional measurement apparatus 10 during measurement, from the plurality of temperature sensors 20 via the communication part 110. The measurement temperature acquisition part 141 acquires, for example, the temperature of each part of the three-dimensional measurement apparatus 10, the environmental temperature, and the temperature of the measurement object to be measured D during measurement of the three-dimensional measurement apparatus 10. The measurement temperature acquisition part 141 may acquire, for each predetermined time period, the temperatures measured by the plurality of temperature sensors 20 at predetermined time intervals while the same measurement item of the measurement object to be measured D is repeatedly measured.

The measurement result acquisition part 142 acquires, via the communication part 110, the measurement result of the object to be measured D measured by the three-dimensional measurement apparatus 10. The measurement result is, for example, the position of a predetermined portion, the position of the center of a circle, the position of the center of a sphere, the diameter of a hole, the distance between end faces, the distance between two predetermined portions, the relative position between two predetermined portions, the shape of the measured element, the posture of the element, or the like. The measurement result may include the area, volume, or the like of the predetermined portion.

The correction value calculation part 143 calculates a correction value of the measurement result using a model formula of the temperature compensation. The model formula of the temperature compensation includes a polynomial composed of values obtained by multiplying each of the plurality of temperatures acquired from the plurality of temperature sensors 20 by coefficients corresponding to each of the plurality of temperature sensors 20.

For example, the correction value calculation part 143 uses the model formula of the temperature compensation shown in the following equation. Here, when the three-dimensional measurement apparatus 10 measures the object to be measured D and outputs a measurement result y, temperatures acquired by the measurement temperature acquisition part 141 from a total of P temperature sensors 20 are defined as xₚ (p is an integer from 1 to P), the correction value calculated by the correction value calculation part 143 is defined as y′, the coefficients corresponding to each of the plurality of temperature sensors 20 are defined as bₚ, and the constant term is defined as b₀.

$${y}^{′} = {\sum }_{p = 1}^{P} {b}_{p} {x}_{p} + {b}_{0} \qquad [ Equation 2 ]$$

The coefficients bₚ (p is an integer from 0 to P) of the model formula including the coefficients bₚ corresponding to each of the plurality of temperature sensors 20 and the constant term b₀ can be identified by learning. For example, the coefficients bₚ of the model formula are values identified so as to minimize an evaluation function L based on a difference between an ideal measurement value obtained by measuring the object to be measured D installed in a constant temperature environment at a predetermined temperature (e.g., T_{E}=20° C.) and the correction value.

Note that the ideal measurement value is a value obtained by measuring the object to be measured D using a three-dimensional measurement apparatus having higher measurement accuracy than the three-dimensional measurement apparatus 10 according to the present embodiment.

$$L = {\sum }_{n = 1}^{N} {( Y - {y}_{n}^{′} )}^{2} \qquad [ Equation 3 ]$$

Here, it is assumed that the ideal measurement value is Y, the measurement result obtained by the measurement result acquisition part 142 is yₙ (n is an integer from 1 to N), and the correction value calculated by the correction value calculation part 143 corresponding to the measurement result yₙ is yₙ′. The coefficients bₚ of the model formula are calculated in advance and stored in the storage 120. By using such coefficients bₚ, the correction value calculation part 143 calculates the correction value y′ which becomes a value closer to 0 when the measurement result of the three-dimensional measurement apparatus 10 becomes a value closer to the ideal measurement value, for example.

The correction part 144 calculates a corrected measurement value, which is a corrected measurement result obtained by adding the correction value y′ to the measurement result or multiplying the correction value y′ by the measurement result. For example, the correction part 144 calculates the corrected measurement value as y+y′. The output part 145 outputs the corrected measurement value calculated by the correction part 144. For example, the output part 145 causes the display part 130 to display the corrected measurement value. The output part 145 may cause the display part 130 to display the corrected measurement value together with the measurement result y. The correction part 144 may store the corrected measurement value in the storage 120, or may output the corrected measurement value to an external server, an external database, or the like.

As described above, the temperature compensation apparatus 100 according to the present embodiment learns relationships between (i) various temperatures such as the temperature of each part of the three-dimensional measurement apparatus 10, the environmental temperature, and the temperature of the object to be measured D and (ii) a value of the measurement error occurring in the object to be measured D, by reflecting said relationships in the coefficients bₚ of the model formula. As a result, even if temperature unevenness occurs in the object to be measured D, the temperature compensation apparatus 100 can calculate the correction value reflecting distribution of the temperature of each part of the three-dimensional measurement apparatus 10 and the environmental temperature corresponding to the temperature unevenness. Therefore, the temperature compensation apparatus 100 can accurately correct the measurement error caused by the temperature in the measurement result of the three-dimensional measurement apparatus 10.

Further, the temperatures output by the plurality of temperature sensors 20 change in response to the change in the environmental temperature, but a temperature of at least a certain part among the temperatures of various parts of the three-dimensional measurement apparatus 10 may not follow the same trend as the change in the temperature of the object to be measured D. For example, the temperature of a portion having a larger heat capacity than the object to be measured D may change more slowly than the temperature of the object to be measured D. In addition, the temperature of a portion having a smaller heat capacity than the object to be measured D may change more quickly than the temperature of the object to be measured D.

In this case, even if the temperature of the object to be measured D is at the same first temperature, a temperature of a predetermined certain part of the three-dimensional measurement apparatus 10 changing from the high temperature side to the first temperature may be different from a temperature of said certain part of the three-dimensional measurement apparatus 10 changing from the low temperature side to the first temperature. The coefficients bₚ of the model formula are learned by reflecting the temperature of each part of the three-dimensional measurement apparatus 10 having a temperature change tendency different from the temperature change tendency of the object to be measured D.

Therefore, the temperature compensation apparatus 100 can calculate a more accurate correction value corresponding to the error corresponding to the actual expansion amount of the object to be measured D even if the temperature of the object to be measured D is at the same first temperature. By doing this, the temperature compensation apparatus 100 can correct the measurement error caused by the temperature of the three-dimensional measurement apparatus 10 which cannot be corrected by the conventional correction formula.

As described above, at least one temperature sensor 20 is provided, among the portions of the three-dimensional measurement apparatus 10, at a position having a temperature change tendency different from the temperature change tendency of the object to be measured D caused by the environmental temperature change. It is preferable that two or more temperature sensors 20 are provided, among the portions of the three-dimensional measurement apparatus 10, at a plurality of positions each having a different temperature change tendency with respect to environmental temperature change. By doing this, there will be a difference in the temperatures detected by the plurality of temperature sensors 20 between a case where the environmental temperature changes significantly and a case where the environmental temperature changes slightly. Therefore, the temperature compensation apparatus 100 can accurately correct the measurement error caused by the temperature in the measurement result of the three-dimensional measurement apparatus 10 even if the degree of change in the environmental temperature changes.

In addition, the temperature compensation apparatus 100 can calculate a correction value for directly correcting the measurement result of the three-dimensional measurement apparatus 10 without using values such as the expansion amount and the expansion rate of the object to be measured D. Therefore, even for various different measurement items of the three-dimensional measurement apparatus 10, by using the coefficients identified on the basis of an evaluation function, the temperature compensation apparatus 100 can easily correct the measurement error caused by the temperature of the three-dimensional measurement apparatus 10 without identifying correction formulas corresponding to the respective measurement items.

### Other Configurations of the Temperature Compensation Apparatus 100

An example has been described in which the temperature compensation apparatus 100 according to the present embodiment performs the temperature compensation using the coefficients of the model formula identified on the basis of the evaluation function, but the present disclosure is not limited thereto. It is also assumed that the environmental temperature of the three-dimensional measurement apparatus 10 significantly fluctuates depending on installation locations, seasons, climates, and the like. Therefore, the temperature compensation apparatus 100 may divide the environmental temperature of the three-dimensional measurement apparatus 10 into a plurality of temperature regions, and identify coefficients of the model formula in advance for each of the divided temperature regions. Further, the temperature compensation apparatus 100 may identify coefficients of the model formula in advance for each environmental temperature of the three-dimensional measurement apparatus 10.

The storage 120 stores a coefficient bp1 identified for when the environmental temperature is equal to or greater than 0° C. but less than 10° C., a coefficient bp2 identified for when the temperature is equal to or greater than 10° C. but less than 20° C., a coefficient bp3 identified for when the environmental temperature is equal to or greater than 20° C. but less than 30° C., and a coefficient bp4 identified for when the environmental temperature is not less than 30° C. and less than 40° C., for example. Then, the correction value calculation part 143 calculates the correction value by switching the coefficients of the model formula to the coefficient that corresponds to the environmental temperature of the three-dimensional measurement apparatus 10 among a plurality of coefficients (for example, bp1, bp2, bp3, and bp4) identified in advance. By doing this, the temperature compensation apparatus 100 can accurately correct the measurement error caused by the temperature in the measurement result of the three-dimensional measurement apparatus 10, by using the coefficient corresponding to the environmental temperature even if the environmental temperature significantly fluctuates.

An example has been described in which the temperature compensation apparatus 100 switches the coefficients of the model formula according to the environmental temperature, but the present disclosure is not limited thereto. The temperature compensation apparatus 100 may switch the coefficients of the model formula according to a measurement time of the three-dimensional measurement apparatus 10. The temperature change tendency of each part of the three-dimensional measurement apparatus 10 may differ depending on a state such as immediately after turning on the power, after a predetermined time has passed since turning on the power, after starting measurement after the installation location of the three-dimensional measurement apparatus 10 has been moved, or the like.

Therefore, the temperature compensation apparatus 100 may divide the measurement time of the three-dimensional measurement apparatus 10 into a plurality of time regions from the start of measurement, and identify coefficients of the model formula in advance for each of the divided time regions. Then, the correction value calculation part 143 calculates the correction value by switching the coefficients corresponding to each of the plurality of temperature sensors 20 to the coefficient identified according to the elapsed time, in accordance with a time period that has passed since the three-dimensional measurement apparatus 10 started the measurement. By doing this, the temperature compensation apparatus 100 can accurately correct the measurement error caused by the temperature in the measurement result of the three-dimensional measurement apparatus 10 by using the coefficient corresponding to the time that has passed since the start of the measurement, even if the temperature change tendency fluctuates according to the time that has passed since the start of the measurement.

Further, the temperature compensation apparatus 100 may switch coefficients of the model formula according to the measurement items of the three-dimensional measurement apparatus 10. Some measurement items of the three-dimensional measurement apparatus 10 are susceptible to fluctuations in environmental temperature, some are less susceptible to fluctuations in environmental temperature, and some are affected in a more complicated manner by fluctuations in environmental temperature.

Therefore, the temperature compensation apparatus 100 may identify a coefficient of the model formula for each measurement item of the three-dimensional measurement apparatus 10 in advance. Then, the correction value calculation part 143 calculates a correction value by switching the coefficients corresponding to each of the plurality of temperature sensors 20 to the coefficient identified according to the measurement item of the three-dimensional measurement apparatus 10, in accordance with the measurement item to be measured by the three-dimensional measurement apparatus 10. By doing this, the temperature compensation apparatus 100 can accurately correct the measurement error caused by the temperature in the measurement result of the three-dimensional measurement apparatus 10 by using the coefficient corresponding to the measurement item.

Further, the temperature compensation apparatus 100 may switch the coefficient of the model formula according to the position or the region of the object to be measured D. Some of the objects to be measured D are susceptible to fluctuations in environmental temperature due to positions, regions, or the like, some are less susceptible to fluctuations in environmental temperature, and some are affected in a more complicated manner by fluctuations in environmental temperature. When the size of the object to be measured D is large, the behavior of the object to be measured D in response to the change in the environmental temperature often differs depending on the position.

Therefore, the temperature compensation apparatus 100 may identify a coefficient of the model formula for each position or region of the object to be measured D. Then, the correction value calculation part 143 calculates the correction value by switching the coefficients corresponding to each of the plurality of temperature sensors 20 to the coefficient identified according to the position of the object to be measured D in accordance with the position of the object to be measured D. Thus, the temperature compensation apparatus 100 can accurately correct the measurement error due to the temperature in the measurement result of the three-dimensional measurement apparatus 10 by using the coefficient corresponding to the position or the region of the object to be measured D.

An example has been described in which the temperature compensation apparatus 100 according to the present embodiment uses Equation 2 as the model formula for temperature compensation, but the present disclosure is not limited to this. The model formula of the temperature compensation may be another model formula as long as it is a polynomial in which the temperatures acquired from the plurality of temperature sensors 20 are reflected. For example, the model formula may include higher-order terms such as quadratic functions, or may include nonlinear terms, terms that use time as a parameter, or the like.

An example has been described in which the temperature compensation apparatus 100 according to the present embodiment uses Equation 3 as the evaluation function L, but the present disclosure is not limited to this. The evaluation function L may be any function as long as a difference between the ideal measurement value and the correction value can be evaluated, and another evaluation function used in machine learning or the like may be used.

An example has been described in which the temperature compensation apparatus 100 according to the present embodiment performs the temperature compensation on the measurement result of the three-dimensional measurement apparatus 10, but the present disclosure is not limited thereto. The temperature compensation apparatus 100 may function as a controller for operating the three-dimensional measurement apparatus 10, for example. Further, the controller for operating the three-dimensional measurement apparatus 10 may function as the temperature compensation apparatus 100 by executing a predetermined program. In this case, a configuration may be used in which one computer can execute the measurement operation of the three-dimensional measurement apparatus 10 and the temperature compensation of the measurement result.

### Operation Flow of the Temperature Compensation Apparatus 100

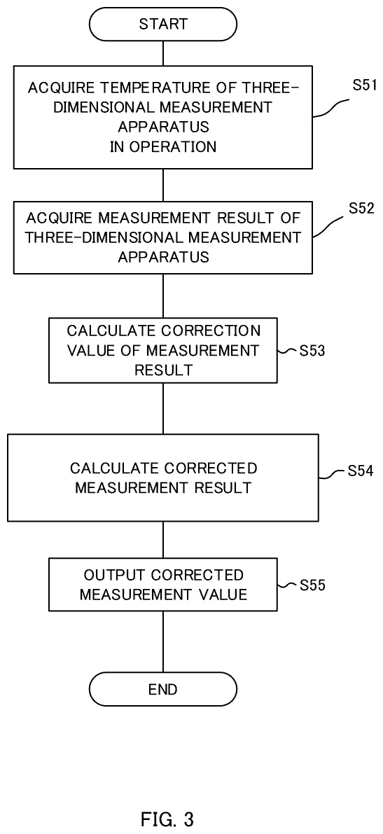

FIG. 3 shows an example of an operation flow of the temperature compensation apparatus 100 according to the present embodiment. By having a computer execute the operation flow shown in FIG. 3, it is possible to perform temperature compensation on a measurement result of the object to be measured D, output by the three-dimensional measurement apparatus 10 installed in a variable temperature environment.

First, the measurement temperature acquisition part 141 acquires temperatures of the three-dimensional measurement apparatus 10 during the measurement, from temperature sensors 20 provided at a plurality of different positions of the three-dimensional measurement apparatus 10 and a temperature sensor 20 that measures an environmental temperature of the three-dimensional measurement apparatus 10 (S51). Next, the measurement result acquisition part 142 acquires a measurement result of the three-dimensional measurement apparatus 10 (S52).

Next, the correction value calculation part 143 calculates a correction value of the measurement result using a model formula of temperature compensation, including a polynomial composed of values obtained by multiplying each of the plurality of temperatures acquired from the plurality of temperature sensors 20 by coefficients corresponding to each of the plurality of temperature sensors 20 (S53). Next, the correction part 144 calculates a corrected measurement value, which is a corrected measurement result obtained by adding together or multiplying together the correction value and the measurement result of the three-dimensional measurement apparatus 10 (S54). Next, the output part 145 outputs the calculated corrected measurement value (S55).

The present disclosure has been described above on the basis of the exemplary embodiments. The technical scope of the present disclosure is not limited to the scope explained in the above embodiments, and it is obvious to those skilled in the art that various changes and modifications within the scope of the invention may be made. An aspect to which such changes and modifications are added can be included in the technical scope of the present disclosure is obvious from the description of the claims.

What is claimed is:

1. A temperature compensation apparatus which performs temperature compensation on a measurement result of an object to be measured, output by a three-dimensional measurement apparatus installed in a variable temperature environment, the temperature compensation apparatus comprising:
a measured temperature acquisition part that acquires temperatures of the three-dimensional measurement apparatus during measurement, from a plurality of temperature sensors provided at a plurality of different positions of the three-dimensional measurement apparatus, a temperature sensor that measures an environmental temperature of the three-dimensional measurement apparatus, and a temperature sensor that measures a temperature of the object to be measured;
a measurement result acquisition part that acquires the measurement result of the object to be measured output by the three-dimensional measurement apparatus;
a correction value calculation part that calculates a correction value of the measurement result using a model formula of temperature compensation, including a polynomial composed of values obtained by multiplying each of a plurality of temperatures acquired from the plurality of temperature sensors by coefficients corresponding to each of the plurality of temperature sensors; and
a correction part that calculates a corrected measurement value, which is a corrected measurement result obtained by adding the correction value to the measurement result or multiplying the correction value by the measurement result, wherein the coefficients corresponding to each of the plurality of temperature sensors are values identified so as to minimize an evaluation function based on a difference between an ideal measurement value obtained by measuring the object to be measured installed in a constant temperature environment at a predetermined temperature and the correction value.

2. The temperature compensation apparatus according to claim 1, wherein the model formula of the temperature compensation used by the correction value calculation part is represented by the following equation:
$${y}^{′} = {\sum }_{p = 1}^{P} {b}_{p} {x}_{p} + {b}_{0} \qquad ( 1 )$$
where temperatures acquired by the measurement temperature acquisition part from a total of P of the temperature sensors are xₚ (p is an integer from 1 to P), the correction value calculated by the correction value calculation part is y′, the coefficients corresponding to each of the plurality of temperature sensors are bₚ, and b₀ is a constant term.

3. The temperature compensation apparatus according to claim 2, wherein the evaluation function is expressed as L in the following equation:
$$L = {\sum }_{n = 1}^{N} {( Y - {y}_{n}^{′} )}^{2} \qquad ( 2 )$$
where the ideal measurement value is Y, the measurement result obtained by the measurement result acquisition part is yₙ (n is an integer from 1 to N), and the correction value calculated by the correction value calculation part corresponding to the measurement result yₙ is yₙ′.

4. The temperature compensation apparatus according to claim 1, wherein the correction value calculation part calculates the correction value by switching the coefficients corresponding to each of the plurality of temperature sensors to the coefficient identified according to the environmental temperature of the three-dimensional measurement apparatus, in accordance with the environmental temperature of the three-dimensional measurement apparatus.

5. The temperature compensation apparatus according to claim 1, wherein the correction value calculation part calculates the correction value by switching the coefficients corresponding to each of the plurality of temperature sensors to the coefficient identified according to an elapsed time, in accordance with a time that has passed since the three-dimensional measurement apparatus started measurement.

6. The temperature compensation apparatus according to claim 1, wherein the correction value calculation part calculates the correction value by switching the coefficients corresponding to each of the plurality of temperature sensors to the coefficient identified according to a measurement item of the three-dimensional measurement apparatus, in accordance with the measurement item to be measured by the three-dimensional measurement apparatus.

7. The temperature compensation apparatus according to claim 1, wherein the correction value calculation part calculates the correction value by switching the coefficients corresponding to each of the plurality of temperature sensors to the coefficient identified according to a position of the object to be measured.

8. The temperature compensation apparatus according to claim 1, wherein the at least one temperature sensor is provided, among portions of the three-dimensional measurement apparatus, at a position having a temperature change tendency different from a temperature change tendency of the object to be measured caused by environmental temperature change.

9. The temperature compensation apparatus according to claim 1, wherein two or more of the temperature sensors are provided, among portions of the three-dimensional measurement apparatus, at positions each having a different temperature change tendency with respect to environmental temperature change.

10. A measurement system comprising:
the three-dimensional measurement apparatus that measures a three-dimensional geometry of the object to be measured;
a plurality of temperature sensors provided at a plurality of different positions of the three-dimensional measurement apparatus; and
the temperature compensation apparatus according to claim 1 that performs temperature compensation on the measurement result of the three-dimensional measurement apparatus on the basis of a plurality of temperatures acquired by the plurality of temperature sensors.

11. A temperature compensation method which performs temperature compensation on a measurement result of an object to be measured, output by a three-dimensional measurement apparatus installed in a variable temperature environment, the temperature compensation method comprising:
acquiring temperatures of the three-dimensional measurement apparatus during measurement, from a plurality of temperature sensors provided at a plurality of different positions of the three-dimensional measurement apparatus, and a temperature sensor that measures an environmental temperature of the three-dimensional measurement apparatus;
acquiring the measurement result;
calculating a correction value of the measurement result using a model formula of temperature compensation, including a polynomial composed of values obtained by multiplying each of a plurality of temperatures acquired from the plurality of temperature sensors by coefficients corresponding to each of the plurality of temperature sensors; and
calculating a corrected measurement value, which is a corrected measurement result obtained by adding the correction value to the measurement result or multiplying the correction value by the measurement result, wherein the coefficients corresponding to each of the plurality of temperature sensors are values identified so as to minimize an evaluation function based on a difference between an ideal measurement value obtained by measuring the object to be measured installed in a constant temperature environment at a predetermined temperature and the correction value.
